(19) United States
(12) Patent Application Publication
(10) Pub. No.: US 2024/0214818 A1
(43) Pub. Date: Jun. 27, 2024

(54) MANAGING PRIVILEGED OPERATION REQUEST MISBEHAVIOR

(71) Applicant: QUALCOMM Incorporated, San Diego, CA (US)

(72) Inventors: William WHYTE, Natick, MA (US); Jonathan PETIT, Wenham, MA (US)

(21) Appl. No.: 18/069,625

(22) Filed: Dec. 21, 2022

(51) Int. Cl. H04W 12/63; H04W 12/069; H04W 12/082

(52) U.S. Cl. CPC H04W 12/63; H04W 12/069; H04W 12/082

(57) ABSTRACT

Various embodiments include methods and systems for managing privileged operation request misbehavior. In various embodiments, a network computing device may receive a first privileged operation request purportedly from a vehicle at a first location at a first time and a second privileged operation request purportedly from the vehicle at a second location at a second time, and may perform a security action in response to determining that the vehicle cannot have traveled from the first location to the second location between the first time and the second time.

### BACKGROUND

Vehicle-to-Everything (V2X) systems support vehicle-to-vehicle and vehicle-to-highway system communications according to communication protocols and messaging formats defined under a relevant standard, such as Cellular Vehicle-to-Everything (C-V2X), Dedicated Short Range Communication (DSRC), and ITS-G5. These standards serve as the foundation for vehicle-based wireless communications, and may be used to support intelligent highways, autonomous and semi-autonomous vehicles, and improve the overall efficiency and safety of the highway transportation systems.

Certain vehicles, such as emergency responder vehicles, may be given priority access to roadways. For example, an intelligent traffic system may attempt to clear other traffic out of the path of the emergency responder vehicle, may change traffic signals to permit the emergency responder vehicle to traverse intersections, and the like. The ability to request such priority access, sometimes referred to as “privileged operation,” is restricted to authorized vehicles (e.g., emergency vehicles, police, etc.) that are typically issued a cryptographic certificate that is unique to each vehicle. However, a malicious actor may steal or duplicate the private key that enables the use of such a certificate, such as by physically extracting the private key from secure key storage on an authorized vehicle or by a cryptographic attack to recover the private key from a certificate obtained from a transmitted message, and improperly request privileged access at other locations. The resulting disruption to the intelligent traffic system may hinder or disrupt normal traffic, and in more serious cases could threaten human safety.

### SUMMARY

Various aspects include methods that may be performed by a network computing device for managing use of privileged access operations to detect and react to misappropriation of certifications and similar misbehavior. In some aspects, a network computing device may receive a first privileged operation request purportedly from a vehicle at a first location at a first time and a second privileged operation request purportedly from the vehicle at a second location at a second time, and may perform a security action in response to determining that the vehicle cannot have traveled from the first location to the second location between the first time and the second time.

In some aspects, determining that the vehicle cannot have traveled from the first location to the second location between the first time and the second time may include determining that a speed of the vehicle required to travel from the first location to the second location between the first time and the second time exceeds a speed threshold. In some aspects, determining that the vehicle cannot have traveled from the first location to the second location between the first time and the second time may include determining that a duration from the first time to the second time is below a time threshold.

In some aspects, determining that the vehicle cannot have traveled from the first location to the second location between the first time and the second time may be based on a geometry of a path between the first location and the second location. In some aspects, determining that the vehicle cannot have traveled from the first location to the second location between the first time and the second time may be based on road conditions between the first location and the second location. Some aspects may include determining the road conditions between the first location and the second location based on vehicle-to-everything (V2X) information received from one or more other vehicles.

Some aspects may include performing the security action in response to determining that the second location is outside of a permitted operation area. In some aspects, performing a security action may include one or more of disapproving the second privileged operation request, notifying other V2X devices to ignore any privileged operation request from the vehicle, or issuing a revocation of a cryptographic certificate associated with the first privileged operation request or the second privileged operation request. In some aspects, the first privileged operation request and the second privileged operation request each include a cryptographic signature based on a cryptographic certificate that was issued to a single vehicle.

Further aspects include a computing device including a memory and a processor configured to perform operations of any of the methods summarized above. Further aspects may include a computing device having various means for performing functions corresponding to any of the methods summarized above. Further aspects may include a non-transitory processor-readable storage medium having stored thereon processor-executable instructions configured to cause a processor of a computing device to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing various embodiments.

FIG. 1C is a system block diagram illustrating a communication system suitable for implementing various embodiments.

FIG. 2 is a component diagram of an example vehicle V2X processing system suitable for implementing various embodiments.

FIG. 3 is a block diagram illustrating an example components of a system on chip (SOC) for use in a processing system in accordance with various embodiments.

FIG. 4 is a component block diagram of a network computing device suitable for use with various embodiments.

FIG. 5A is a process flow diagram of an example method performed by a processor of network computing device for managing privileged operation request misbehavior in accordance with various embodiments.

FIG. 5B is a process flow diagram of example operations that may be performed by a processor of a computing device as part of the method for managing privileged operation request misbehavior in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Priority or special access to roadways, through traffic signals and/or other uses of traffic system resources by authorized vehicles are referred to herein as “privileged operations.” A request by a vehicle computing system to be granted privileged operation is referred to herein as a “privileged operation request.” Such requests typically include a certificate that was issued to an authorized vehicle, which enables an intelligence highway system (IHS) to authenticate the requesting vehicle and verify that the vehicle is authorized to by provided with the requested privilege operation (e.g., changing a traffic light to green, opening a traffic barrier, etc.) As described herein, providing authorized vehicles with privilege operations can enable emergency vehicles (e.g., ambulances, fire trucks, police vehicles, etc.) to speed through traffic and thus respond more rapidly to emergency situations and urgent needs.

Various embodiments include methods, and computing devices implementing the methods, for detecting misappropriation of privileged access certificates and unauthorized use of such certificates in privileged operation requests from vehicle computing systems. In various embodiments, a network computing device may include one or more processors and/or other components configured to perform operations for detecting spurious or unauthorized requests for privileged operation, which is referred to herein as “privileged operation request misbehavior.”

As used herein, the term “vehicle” refers generally to any of an automobile, motorcycle, truck, bus, train, boat, and any other type of vehicle V2X-capable system that may be configured to manage transmission of misbehavior reports.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

One potential benefit of V2X systems or intelligent traffic/transportation systems (ITS) is to enable emergency response vehicles (e.g., ambulances, emergency medical response vehicles, police vehicles, fire vehicles, etc.) to request priority access to roadways and/or other traffic system resources, such as traffic signals, in order to, for example, get to a scene of an incident or a hospital faster. Vehicles that are authorized for privileged operation and that are V2X-enabled may be issued unique cryptographic certificates with which vehicle computing system may sign a privileged operation request. Cryptographic binding of the cryptographic certificate to the request purports that the privileged operation request has come from an authorized vehicle. A privileged operation request that is not cryptographically bound to an authorized cryptographic certificate typically will be rejected or ignored by the V2X system or ITS. In some implementations, the certificate may be public, but a private key corresponding to the certificate, which may be used to generate a cryptographic signature, may be stored in secured hardware in an authorized vehicle.

However, if such secured hardware is compromised and the private key extracted, the private key may be used to construct and send an improper (i.e., unauthorized) privileged operation request, i.e., privileged operation request misbehavior. Privileged operation request misbehavior by a single vehicle may be manageable, because disruption to the V2X system caused by such misbehavior is similar to traffic disruption caused by a legitimate privileged vehicle. However, multiple vehicles performing privileged operation request misbehavior in different locations at approximately the same or similar times may cause traffic disruptions across a region or area that may hinder or disrupt normal traffic. In more serious cases, such misbehaviors could threaten human safety, for example by causing accidents or hindering operations of legitimate emergency responders. Further, an attacker in possession of one or more misappropriated certificates could disrupt emergency and normal operations of a city or an intelligent highway system by flooding the system with spurious privileged operation requests.

Various embodiments include methods, and network computing devices implementing the methods, for recognizing and responding to privileged operation request misbehavior. In various embodiments, a network computing device may receive a first privileged operation request purportedly from a vehicle at a first location at a first time and a second privileged operation request purportedly from the vehicle at a second location at a second time. The network computing device may perform a security action in response to determining that the vehicle cannot have traveled from the first location to the second location between the first time and the second time. The methods identify when the first privileged operation request and the second privileged operation request both include a cryptographic signature based on a cryptographic certificate that was issued to a single vehicle, namely properly authorized vehicle.

In some embodiments, the network computing device may maintain a record of each privileged operation request that the network computing device receives. Such records may include various data related to each privileged operation request, such as the time, and location, cryptographic signature and/or cryptographic certificate, and/or other relevant data of the requesting vehicle. The network computing device may monitor such records to recognize when two or more records reveal that two privileged operation request signed using the same cryptographic certificate are received by the network computing device. The use of the same cryptographic certificate indicates that the two (or more) requests purportedly were issued by the same vehicle. The network computing device may be configured to compare the locations of the multiple privileged operation requests and the time interval between the multiple privileged operation requests to determine whether a single vehicle could have traveled between the location of the first privileged operation request (“first location”) to the location of a second (or later) privileged operation request (“second location”). In some embodiments, the network computing device may determine that there has been privileged operation request misbehavior in response to determining that the speed of a vehicle required to travel from the first location to the second location in the interval between the first time and the second time exceeds a speed threshold, such as a maximum speed that a vehicle could achieve on a given roadway or possible driving route based on speed limits, road conditions, etc. In some embodiments, the network computing device may determine that there has been privileged operation request misbehavior in response to determining that the duration between the first time to the second time is less than a time threshold, such as less than a requesting interval of the vehicle computing device, less than a minimum time it would take a vehicle to travel from the first location to the second location given roadway conditions or possible driving route, or other factors.

In some embodiments, the network computing device may be configured to obtain and use additional V2X information in determining that the vehicle cannot have traveled from the first location to the second location between the first time and the second time. In some embodiments, the network computing device may determine that the vehicle cannot have traveled from the first location to the second location between the first time and the second time based on a street map or geometry of possible pathways between the first location and the second location. In some embodiments, the network computing device may determine that the vehicle cannot have traveled from the first location to the second location between the first time and the second time based on road conditions between the first location and the second location, such condition of paving (if any), presence of speed barriers, width of roadway, etc. In some embodiments, the network computing device may determine road conditions between the first location and the second location based on V2X information received from one or more other vehicles.

In some embodiments, use of the cryptographic certificate may be limited or restricted to a permitted operation area. Such operation areas may include, for example, a geofence, a municipal or city limit, a jurisdiction of a police vehicle, an operating range of the certified vehicle, or another definable geographic area. In some embodiments, the operation area may include a path (e.g., a roadway or another suitable travel route) for which the vehicle has requested privileged operation, such as a driving route to a hospital, or to an accident scene. In some embodiments, the network computing device may perform the security action in response to determining that the second location (of the second privileged operation request) is outside of a permitted operation area. Such embodiments may enable the network computing device to identify the vehicle issuing the second privileged operation request from outside the permitted operation area as the misbehaving vehicle.

The network computing device may respond to detecting privileged operation request misbehavior more rapidly than a certificate authority or other issuer of the cryptographic certificate can, which may be limited to revoking and/or changing the certificate and informing nodes in the intelligent highway system of that action. In some embodiments, the network computing device may perform a security action that includes disapproving (rejecting) the second privileged operation request (i.e., denying the requested privilege operation) and/or notifying other V2X systems, such as other V2X-enables vehicles and/or V2X infrastructure devices (e.g., roadside units), to ignore any privileged operation request purporting to be from the vehicle.

In some embodiments, the network computing device may issue a revocation of the cryptographic certificate associated with the first and second privileged operation requests. In such embodiments, the network computing device may issue such revocation of the cryptographic certificate without first communicating with the certificate authority. In some embodiments, the revocation issued by the network computing device may be temporary, for example, for a period of minutes, hours, or days.

Various embodiments improve the safety and efficiency of V2X vehicles and systems by enabling network computing devices to rapidly detect and take appropriate action in response to detected privileged operation request misbehavior. Various embodiments improve the safety and operation of systems in which such computing devices are deployed by enabling computing devices to reduce or eliminate disruptions to traffic and V2X system operations caused by a vehicle or attacker using a misappropriated certificate in various types of privileged operation request misbehaviors.

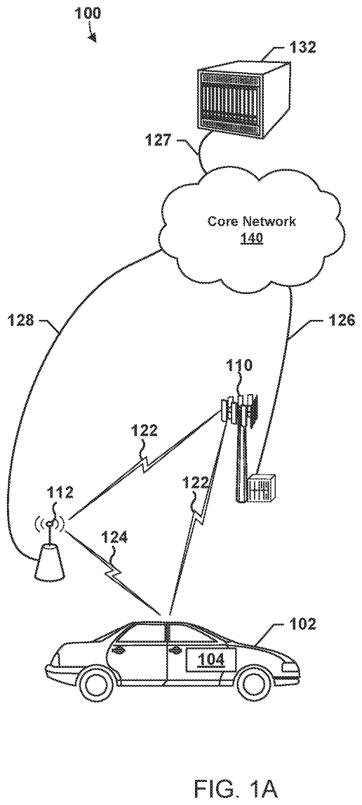

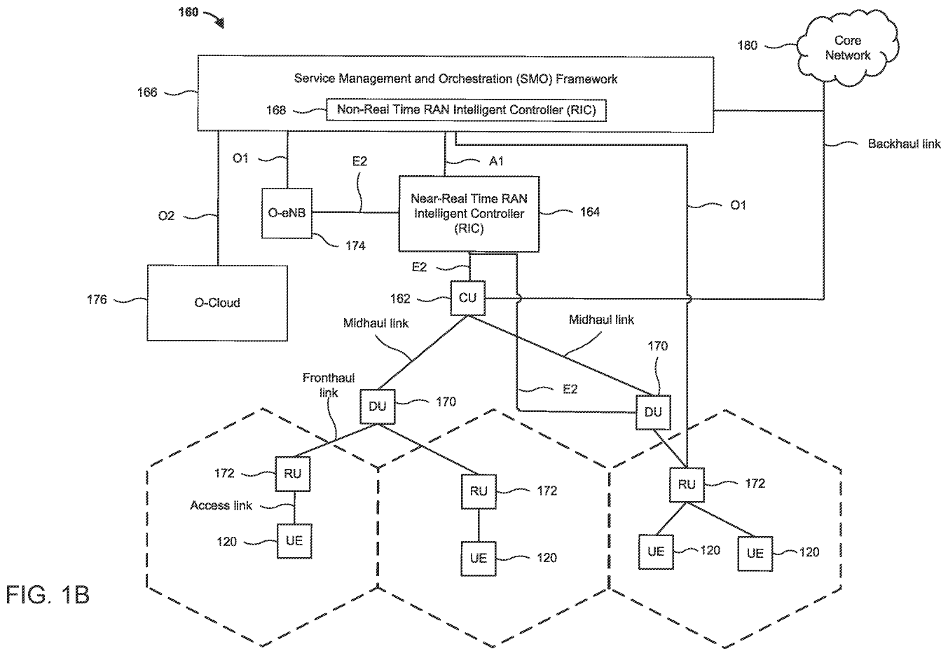

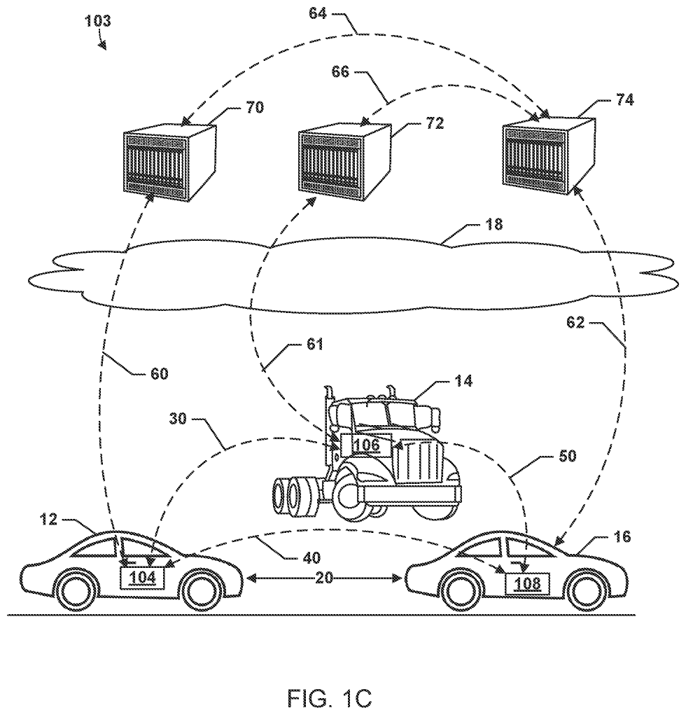

FIG. 1A is a system block diagram illustrating an example communication system 100 suitable for implementing the various embodiments. The communications system 100 include a 5G New Radio (NR) network, an intelligent transportation system (ITS) V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including a vehicle 102 equipped with a V2X processing system 104 that includes wireless communication capabilities. The base station 110 may communicate with a core network 140 over a wired communication link 126. The communications system 100 also may include roadside units 112 supporting V2X communications with vehicles 102 via V2X wireless communication links 124.

A base station 110 is a network element that communicates with wireless devices (e.g., a V2X processing system 104 of the vehicle 102) via a wireless communication link 122, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Roadside units 112 may communicate with the core network 140 via a wired or wireless communication link 128. Roadside units 112 may communicate via V2X wireless communication links 124 with V2X processing system-equipped vehicles 102 for downloading information useful for V2X processing system autonomous and semi-autonomous driving functions, and for receiving information such as misbehavior reports from the V2X processing system 104.

A Misbehavior Authority network computing device (MA) 132 may communicate with the core network 140 via a wired or wireless communication link 127. The MA 132 may receive misbehavior reports from the V2X processing system 104 as may be sent by the V2X processing system 104 from time to time. In various embodiments, the MA 132, or another similar network computing device, may be configured to perform operations to detect and respond to privileged operation request misbehavior.

Wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network (e.g., the communication system 100) according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a V2X processing system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

FIG. 1C is a system block diagram illustrating a communication system 103 suitable for implementing various embodiments. With reference to FIGS. 1A-1C, the communication system 103 may include three vehicles 12, 14, 16. Each vehicle 12, 14, 16 may include a V2X processing system 104, 106, 108, respectively, each configured to periodically broadcast V2X messages 30, 40, 50 such as BSM, CAM, MCM, MAP, SRM, and other types of V2X messages for receipt and processing by other vehicles' V2X processing systems (e.g., 104, 106, 108).

By sharing the vehicle location, speed, direction, braking, and other information, vehicles can maintain safe separation and identify and avoid potential collisions. For example, a trailing vehicle 12 receiving V2X messages 40 from a leading vehicle 16 can determine the speed and location of the vehicle 16, which in turn enables vehicle 12 to match the speed and maintain a safe separation distance 20.

By being informed through V2X messages 40 when the leading vehicles 16 applies the brakes, the V2X processing system 102 in the trailing vehicle 12 can apply brakes simultaneously to maintain the safe separation distance 20 even when the leading vehicle 16 stops suddenly. As another example, the V2X processing system 104 within the truck vehicle 14 may receive V2X messages 30, 50 from the two vehicles 12, 16, and thus be informed that the truck vehicle 14 should stop at the intersection to avoid a collision.

Each of the vehicle V2X on-board equipment 104, 106, 108 may communicate with one another using any of a variety close proximity communication protocols. In addition, the vehicles may be able to transmit data and information regarding detected V2X messages as well as a misbehavior report about detected V2X misbehavior to an original equipment manufacturer (OEM) (70, 72) and/or MA 74 (e.g., 132) via communication links 60, 61, 62 through a communication network 18. The misbehavior report may be transmitted directly to the MA 74 (e.g., via communication link 64, 66).

In some embodiments, the misbehavior report may first be transmitted to a misbehavior report pre-processing unit such as the OEM servers 70, 72 for pre-processing through communication links 64, 66. Then the pre-processed misbehavior report may be transmitted from the misbehavior report pre-processing servers 70, 72 to the MA 74 through communication links 64, 66.

In some embodiments, a misbehavior report may be received from a vehicle, such as from vehicle 16, at the MA 74. The MA 74 may relay the received misbehavior report from the vehicle 16 onto OEM servers 70, 72 via communication links 64, 66. In addition, the OEM servers 70, 72 may provide confirmation reports to the MA 74 via communication links 64, 66.

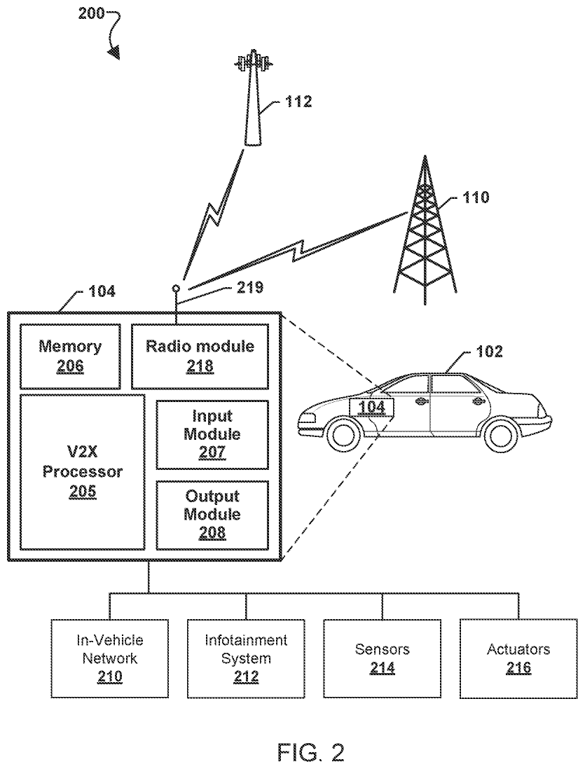

FIG. 2 is a component diagram of an example vehicle V2X processing system 200 suitable for implementing various embodiments. With reference to FIGS. 1A-2, the processing system 200 may include a vehicle 102 that includes a V2X processing system 104. The vehicle V2X processing system 104 may communicate with various systems and devices, such as an in-vehicle network 210, an infotainment system 212, various sensors 214, various actuators 216, and a radio module 218 coupled to an antenna 219. The vehicle V2X processing system 104 also may communicate with roadside units 112, cellular communication network base stations 110, and other external devices.

The V2X processing system 104 may include a processor 205, memory 206, an input module 207, an output module 208, and the radio module 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The V2X processing system 104 may include a V2X antenna 219 coupled to the radio module 218 that is configured to communicate with one or more ITS participants (e.g., stations), a roadside unit 112, and a base station 110 or another suitable network access point. The V2X antenna 219 and radio module 218 may be configured to receive dynamic traffic flow feature information via vehicle-to-everything (V2X) communications. In various embodiments, the V2X processing system may receive information from a plurality of information sources, such as the in-vehicle network 210, infotainment system 212, various sensors 214, various actuators 216, and the radio module 218. The V2X processing system may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, a camera, radar, lidar, ultrasonic sensors, infrared sensors, and other suitable sensor devices and systems. Examples of vehicle actuators 216 include various physical control systems such as for steering, brakes, engine operation, lights, directional signals, and the like.

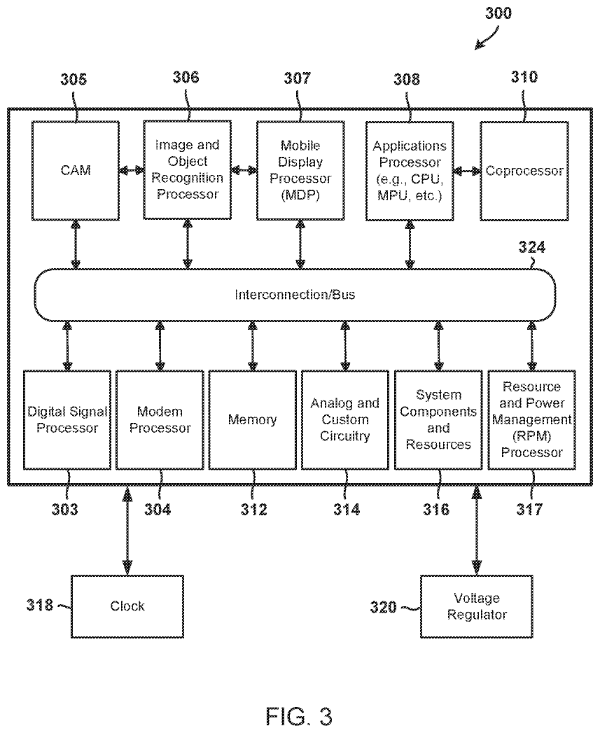

FIG. 3 is a block diagram illustrating an example components of a system on chip (SOC) 300 for use in a processing system (e.g., a V2X processing system) in accordance with various embodiments. With reference to FIGS. 1A-3, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles. In some embodiments, the processor 306 may be configured to process radar or lidar data.

The system components and resources 316, analog and custom circuitry 314, and/or CAM 305 may include circuitry to interface with peripheral devices, such as cameras, radar, lidar, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, Wi-Fi, etc.), and other well-known components of modern electronic devices.

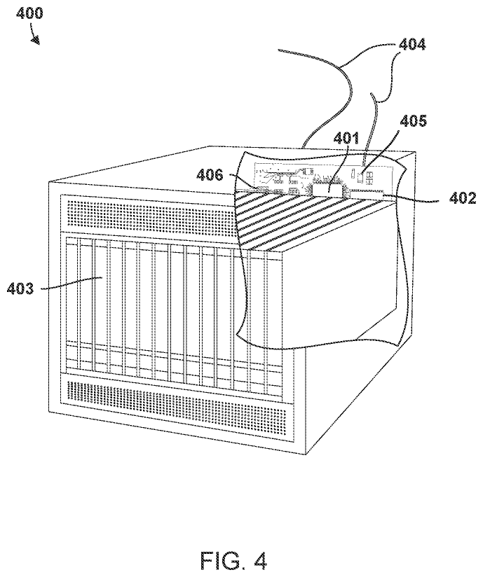

FIG. 4 is a component block diagram of a network computing device 400 suitable for use with various embodiments. With reference to FIGS. 1A-4, various embodiments may be implemented on a variety of network computing devices, an example of which is illustrated in FIG. 4 in the form of a server device. A network computing device 400 may include a processor 401 coupled to volatile memory 402 and a large capacity nonvolatile memory, such as a disk drive 403. The network computing device 400 may also include a peripheral memory access device such as a floppy disc drive, compact disc (CD) or digital video disc (DVD) drive 406 coupled to the processor 401. The network computing device 400 may also include network access ports 404 (or interfaces) coupled to the processor 401 for establishing data connections with a network, such as the Internet and/or a local area network coupled to other system computers and servers. The network computing device 400 may include one or more transceivers 405 for sending and receiving electromagnetic radiation that may be connected to a wireless communication link. The network computing device 400 may include additional access ports, such as USB, Firewire, Thunderbolt, and the like for coupling to peripherals, external memory, or other devices. The processor 401 may include any or all of the elements or components of the processing device SOC 300.

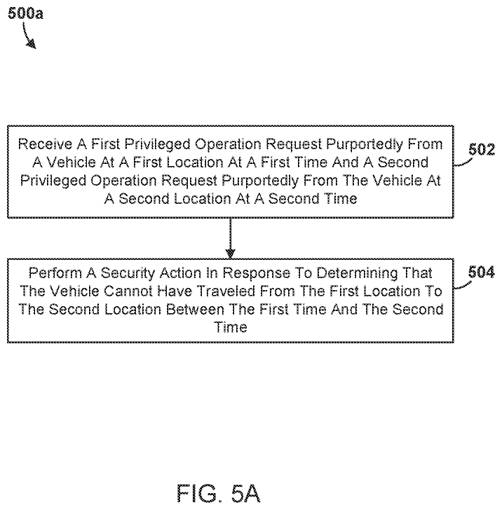

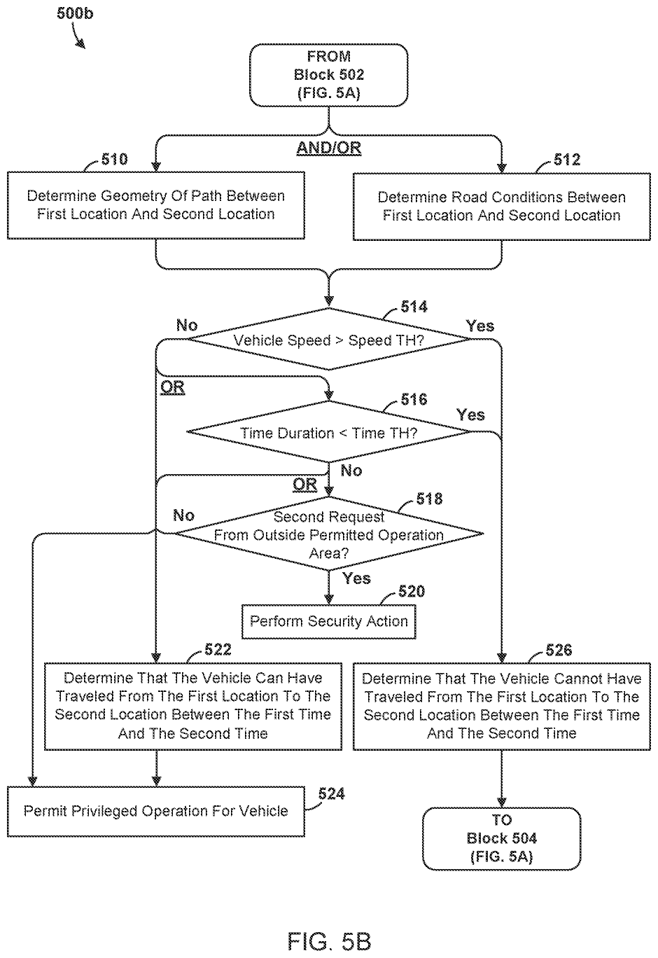

FIG. 5A is a process flow diagram of an example method 500a performed by a processor of network computing device for managing privileged operation request misbehavior in accordance with various embodiments. With reference to FIGS. 1A-5A, the method 500a may be performed by one or more processors (e.g., 300) of a network computing device (e.g., 70, 72, 74, 112, 110, 132, 400) that may be implemented in hardware elements, software elements, or a combination of hardware and software elements. To encompass any of the processors, hardware elements and software element that may be involved in performing the method 500a, the element or subsystems performing method operations are referred to generally as a “processor.”

In block 502, the processor may receive a first privileged operation request purportedly from a vehicle at a first location at a first time and a second privileged operation request purportedly from the vehicle at a second location at a second time. In some embodiments, the first privileged operation request and the second privileged operation request each may include a cartographic signature based on a cryptographic certificate that was issued to a single vehicle. In some embodiments, the processor may store each privileged operation request in memory.

In block 504, the processor may perform a security action in response to determining that the vehicle cannot have traveled from the first location to the second location between the first time and the second time. In some embodiments, the processor may determine that a speed of the vehicle required to travel from the first location to the second location between the first time and the second time exceeds a speed threshold. In some embodiments, the processor may determine that the duration from the first time to the second time is below a time threshold. In some embodiments, the processor may compare newly received requests to stored records of previously received requests in block 504 as part of determining whether the vehicle could have or cannot have traveled from the first location to the second location between the first time and the second time.

The operations in the method 500a may be performed each time a privileged operation request is received.

FIG. 5B is a process flow diagram of example operations 500b that may be performed by a processor of a computing device as part of the method 500a for managing privileged operation request misbehavior in accordance with various embodiments. With reference to FIGS. 1A-5B, the operations 500b may be performed by one or more processors (e.g., 300) of a network computing device (e.g., 70, 72, 74, 112, 110, 132, 400) that may be implemented in hardware elements, software elements, or a combination of hardware and software elements. To encompass any of the processors, hardware elements and software element that may be involved in performing the operations 500b, the element or subsystems performing method operations are referred to generally as a “processor.”

After receiving the first privileged operation request and the second privileged operating request in block 502 as described, the processor may determine a geometry of the path between the first location in the second location in block 510. In some embodiments, the geometry of the path may include a path length, a path shape, one or more turns along the path, one or more elevation changes along the path, a path complexity, and/or other suitable factors.

Additionally or alternatively, after receiving the first privileged operation request and the second privileged operating request in block 502 as described, the processor may determine road conditions between the first location and the second location in block 512. In some embodiments, the processor may determine the road conditions based on V2X information received from one or more other vehicles, such as V2X-enabled vehicles.

After determining the geometry of the path between the first location in the second location in block 510 and/or determining the road conditions between the first location and the second location in block 512 as described, the processor may determine whether a speed of the vehicle required to travel from the first location to the second location between the first time and the second time exceeds a speed threshold in determination block 514.

In response to determining that the speed of the vehicle required to travel from the first location to the second location between the first time and the second time exceeds a speed threshold (i.e., determination block 514=“Yes”), the processor may determine that the vehicle cannot have traveled from the first location to the second location between the first time and the second time in block 526.

In response to determining that the speed of the vehicle required to travel from the first location to the second location between the first time and the second time does not exceed the speed threshold (i.e., determination block 514=“No”), the processor may determine that the vehicle could have traveled from the first location to the second location between the first time and the second time in block 522. In other words, the processor may determine that the speed required to travel between the first and second locations within the interval between the first time and the second time is within what an authorized vehicle could maintain (e.g., a vehicle using siren and entitled to the right of way). In that case, the processor may permit the requested privileged operation for the vehicle in block 524.

Alternatively, in response to determining that the speed of the vehicle required to travel from the first location to the second location between the first time and the second time does not exceed the speed threshold (i.e., determination block 514=“No”), the processor may determine whether a duration from the first time to the second time is below a time threshold in determination block 516.

In response to determining that the duration from the first time to the second time is below the time threshold (i.e., determination block 516=“Yes”), the processor may determine that the vehicle could have traveled from the first location to the second location between the first time and the second time in block 522.

In response to determining that the duration from the first time to the second time is not below the time threshold (i.e., determination block 516=“No”), the processor may determine that the vehicle could have traveled from the first location to the second location between the first time and the second time in block 522. In other words, the interval between the first time and the second time is sufficiently long to have permitted an authorized vehicle (e.g., a vehicle using siren and entitled to the right of way) to reach the second location. In that case, the processor may permit the requested privileged operation for the vehicle in block 524.

Alternatively, in response to determining that the duration from the first time to the second time is not below the time threshold (i.e., determination block 516=“No”), the processor may determine whether the second request is from a location that is outside a permitted operation area in determination block 518.

In response to determining that second request is from a location that is outside the permitted operation area (i.e., determination block 518=“Yes”), the processor may perform a security action in block 520.

In response to determining that second request is from a location within the permitted operation area (i.e., determination block 518=“No”), the processor may permit privileged operation for the vehicle in block 524.

Following the performance of the operations of block 526, the processor may perform a security operation in block 504 as described.

The operations in the method 500b may be performed each time a privileged operation request is received.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 500a and 500b may be substituted for or combined with one or more operations of the methods or operations 500a and 500b.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method of managing privileged operation request misbehavior, including receiving, by a network computing device, a first privileged operation request purportedly from a vehicle at a first location at a first time and a second privileged operation request purportedly from the vehicle at a second location at a second time, and performing a security action in response to determining that the vehicle cannot have traveled from the first location to the second location between the first time and the second time.

Example 2. The method of example 1, in which determining that the vehicle cannot have traveled from the first location to the second location between the first time and the second time includes determining that a speed of the vehicle required to travel from the first location to the second location between the first time and the second time exceeds a speed threshold.

Example 3. The method of either of examples 1 or 2, in which determining that the vehicle cannot have traveled from the first location to the second location between the first time and the second time includes determining that a duration from the first time to the second time is below a time threshold.

Example 4. The method of any of examples 1-3, in which determining that the vehicle cannot have traveled from the first location to the second location between the first time and the second time is based on a geometry of a path between the first location and the second location.

Example 5. The method of any of examples 1-4, in which determining that the vehicle cannot have traveled from the first location to the second location between the first time and the second time is based on road conditions between the first location and the second location.

Example 6. The method of example 5, further including determining the road conditions between the first location and the second location based on vehicle-to-everything (V2X) information received from one or more other vehicles.

Example 7. The method of any of examples 1-6, further including performing the security action in response to determining that the second location is outside of a permitted operation area.

Example 8. The method of any of examples 1-7, in which performing a security action includes one or more of disapproving the second privileged operation request, notifying other V2X devices to ignore any privileged operation request from the vehicle, or issuing a revocation of a cryptographic certificate associated with the first privileged operation request or the second privileged operation request.

Example 9. The method of any of examples 1-8, in which the first privileged operation request and the second privileged operation request each include a cryptographic signature based on a cryptographic certificate that was issued to a single vehicle.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing privileged operation request misbehavior, comprising:
receiving, by a network computing device, a first privileged operation request purportedly from a vehicle at a first location at a first time and a second privileged operation request purportedly from the vehicle at a second location at a second time; and
performing a security action in response to determining that the vehicle cannot have traveled from the first location to the second location between the first time and the second time.

2. The method of claim 1, wherein determining that the vehicle cannot have traveled from the first location to the second location between the first time and the second time comprises determining that a speed of the vehicle required to travel from the first location to the second location between the first time and the second time exceeds a speed threshold.

3. The method of claim 1, wherein determining that the vehicle cannot have traveled from the first location to the second location between the first time and the second time comprises determining that a duration from the first time to the second time is below a time threshold.

4. The method of claim 1, wherein determining that the vehicle cannot have traveled from the first location to the second location between the first time and the second time is based on a geometry of a path between the first location and the second location.

5. The method of claim 1, wherein determining that the vehicle cannot have traveled from the first location to the second location between the first time and the second time is based on road conditions between the first location and the second location.

6. The method of claim 5, further comprising determining the road conditions between the first location and the second location based on vehicle-to-everything (V2X) information received from one or more other vehicles.

7. The method of claim 1, further comprising performing the security action in response to determining that the second location is outside of a permitted operation area.

8. The method of claim 1, wherein performing the security action comprises one or more of disapproving the second privileged operation request, notifying other V2X devices to ignore any privileged operation request from the vehicle, or issuing a revocation of a cryptographic certificate associated with the first privileged operation request or the second privileged operation request.

9. The method of claim 1, wherein the first privileged operation request and the second privileged operation request each include a cryptographic signature based on a cryptographic certificate that was issued to a single vehicle.

10. A network computing device, comprising:
a processor configured with processor-executable instructions to:
receive a first privileged operation request purportedly from a vehicle at a first location at a first time and a second privileged operation request purportedly from the vehicle at a second location at a second time; and
perform a security action in response to determining that the vehicle cannot have traveled from the first location to the second location between the first time and the second time.

11. The network computing device of claim 10, wherein the processor is further configured with processor-executable instructions to determine that a speed of the vehicle required to travel from the first location to the second location between the first time and the second time exceeds a speed threshold.

12. The network computing device of claim 10, wherein the processor is further configured with processor-executable instructions to determine that a duration from the first time to the second time is below a time threshold.

13. The network computing device of claim 10, wherein the processor is further configured with processor-executable instructions to determine that the vehicle cannot have traveled from the first location to the second location between the first time and the second time based on a geometry of a path between the first location and the second location.

14. The network computing device of claim 10, wherein the processor is further configured with processor-executable instructions to determine that the vehicle cannot have traveled from the first location to the second location between the first time and the second time based on road conditions between the first location and the second location.

15. The network computing device of claim 14, wherein the processor is further configured with processor-executable instructions to determine the road conditions between the first location and the second location based on vehicle-to-everything (V2X) information received from one or more other vehicles.

16. The network computing device of claim 10, wherein the processor is further configured with processor-executable instructions to perform the security action in response to determining that the second location is outside of a permitted operation area.

17. The network computing device of claim 10, wherein the processor is further configured with processor-executable instructions to perform one or more of:
disapprove the second privileged operation request;
notify other V2X devices to ignore any privileged operation request from the vehicle; or
issue a revocation of a cryptographic certificate associated with the first privileged operation request or the second privileged operation request.

18. The network computing device of claim 10, wherein the processor is further configured with processor-executable instructions such that the first privileged operation request and the second privileged operation request each include a cryptographic signature based on a cryptographic certificate that was issued to a single vehicle.

19. A network computing device, comprising:
means for receiving a first privileged operation request purportedly from a vehicle at a first location at a first time and a second privileged operation request purportedly from the vehicle at a second location at a second time; and
means for performing a security action in response to determining that the vehicle cannot have traveled from the first location to the second location between the first time and the second time.

20. The network computing device of claim 19, wherein means for determining that the vehicle cannot have traveled from the first location to the second location between the first time and the second time comprises means for determining that a speed of the vehicle required to travel from the first location to the second location between the first time and the second time exceeds a speed threshold.

21. The network computing device of claim 19, wherein means for determining that the vehicle cannot have traveled from the first location to the second location between the first time and the second time comprises means for determining that a duration from the first time to the second time is below a time threshold.

22. The network computing device of claim 19, wherein means for determining that the vehicle cannot have traveled from the first location to the second location between the first time and the second time comprises means for using a geometry of a path between the first location and the second location to determine that the vehicle cannot have traveled along the path between the first time and the second time.

23. The network computing device of claim 19, wherein means for determining that the vehicle cannot have traveled from the first location to the second location between the first time and the second time comprises means for using road conditions between the first location and the second location to determine that the vehicle cannot have traveled between the first time and the second time.

24. The network computing device of claim 23, further comprising means for determining the road conditions between the first location and the second location based on vehicle-to-everything (V2X) information received from one or more other vehicles.

25. The network computing device of claim 19, further comprising means for performing the security action in response to determining that the second location is outside of a permitted operation area.

26. The network computing device of claim 19, wherein means for performing a security action comprises one or more of:
means for disapproving the second privileged operation request;
means for notifying other V2X devices to ignore any privileged operation request from the vehicle; or
means for issuing a revocation of a cryptographic certificate associated with the first privileged operation request or the second privileged operation request.

27. The network computing device of claim 19, wherein the first privileged operation request and the second privileged operation request each include a cryptographic signature based on a cryptographic certificate that was issued to a single vehicle.

28. A non-transitory processor-readable medium having stored thereon processor-executable instructions configured to cause a processing device in a network computing device to perform operations comprising:
receiving a first privileged operation request purportedly from a vehicle at a first location at a first time and a second privileged operation request purportedly from the vehicle at a second location at a second time; and
performing a security action in response to determining that the vehicle cannot have traveled from the first location to the second location between the first time and the second time.
